(19) United States
(12) Patent Application Publication
(10) Pub. No.: US 2023/0367631 A1
(43) Pub. Date: Nov. 16, 2023

(54) Multitenant, Scalable, and Loosely Coupled Simulation Service to Improve Access, Efficiency, Model Sharing, and Reproducibility

(71) Applicant: Google LLC, Mountain View, CA (US)

(72) Inventors: Aradhya Biswas, Sunnyvale, CA (US); Yi-Fan Chen, Cupertino, CA (US)

(21) Appl. No.: 17/744,207

(22) Filed: May 13, 2022

(51) Int. Cl. G06F 9/48; G06F 11/30; G06F 11/34

(52) U.S. Cl. CPC G06F 9/4881; G06F 11/302; G06F 11/3457

(57) ABSTRACT

The present disclosure relates to computer-implemented systems and methods for sharing, managing, and executing computer simulations via a simulation service. In one particular embodiment, the simulation service is stored and executed on a remote computing device wherein the simulation service and remote computing device are configured to interface with client devices or programs. In some instances, input data and configuration parameters may be sent from the client devices or programs to the remote computing device to execute a given computer simulation, and the results may be returned to the client devices or programs as they become available.

### FIELD

The present disclosure relates generally to computer simulation execution and storage. More particularly, the present disclosure relates to hosting and executing computer simulations in an agnostic cloud-based service.

### BACKGROUND

Computer simulations are pieces of computer software (e.g., which are typically large in size) that can be used to imitate or predict a given outcome or event in the physical world without having to actively perform it. Due to the large number of variables and possibilities in any given real-world event, computer simulations can be incredibly complex and require dedicated hardware. This results in limited accessibility and flexibility when attempting to transfer or execute a computer simulation away from where it was created. This reduces the repeatability of computer simulations across different computing systems and/or organizations.

### SUMMARY

Aspects and advantages of embodiments of the present disclosure will be set forth in part in the following description, or can be learned from the description, or can be learned through practice of the embodiments.

One example aspect of the present disclosure is directed to a computing system for executing software simulations. The system can include one or more processors; a computer readable storage medium comprising one or more computer simulations; and a simulation management pipeline comprising a simulation engine, a scheduler, and an input interface. The simulation engine can be configured to run the one or more computer simulations stored within the computer-readable storage medium. The scheduler can be configured to queue the one or more computer simulations for the simulation engine. The input interface can be configured to receive configuration parameters for the one or more computer simulations stored within the computing system.

In some implementations, the simulation engine is further configured to run the one or more computer simulations based on the configuration parameters sent to the input interface via the client computing device.

In some implementations, the simulation engine comprises a plurality of computing devices, and each of the plurality of computing devices is capable of running one or more computer simulations.

In some implementations, the computing system further comprises one or more client computing device configured to send configuration parameters to the input interface of the simulation management pipeline.

In some implementations, the one or more computer simulations are uploaded to the computer-readable storage medium via the one or more client computing devices.

In some implementations, the input interface is further configured to output the results of the simulation engine to the one or more client computing devices or one or more other computing devices.

In some implementations, the results of the simulation engine are output to the client computing device as soon as they are generated.

In some implementations, the results of the simulation engine are input to a visualizer to generate a results visualization that is output to the client computing device.

In some implementations, the simulation management pipeline further comprises a simulation monitoring service configured to monitor the simulation management pipeline and the simulation engine during execution of the one or more computer simulations.

In some implementations, the simulation monitoring service is further configured to modify the execution of the one or more computer simulations when an error occurs during the execution.

Another example aspect is directed to a computer-implemented method for executing computer simulations. The method can include receiving, by a computing system comprising one or more computing devices, one or more configuration parameters from a client device; queueing, by a scheduler, a computer simulation configured based on the configuration parameters from the client device to be executed by one or more simulation engines; executing, by the one or more simulation engines, the computer simulation and storing the results in the computing system; and sending, from the one or more computing devices, the results output from the computer simulation to the one or more client devices.

In some implementations, the method further includes receiving, by the computing system, input data from the one or more client devices.

In some implementations, the method further includes uploading, by the one or more client devices, one or more computer simulations to the computing system to be stored and executed.

In some implementations, the method further includes configuring, by the one or more client devices, permissions of the one or more computer simulations uploaded to the computing system that control how the one or more computer simulations may be executed and who the one or more computer simulations may be executed by.

In some implementations, the results output from the computer simulation to the client device are transmitted as soon as they are available.

In some implementations, the results output from the computer simulation are sent to a visualizer to generate a visualization of the results and the visualization is output to the one or more client devices.

In some implementations, the computing system further comprises a simulation monitoring service.

In some implementations, the method further includes monitoring, by the simulation monitoring service, the one or more simulation engines to detect errors during an execution of the computer simulation.

In some implementations, the method further includes modifying, by the simulation monitoring service, the execution of the computer simulation after detecting an error during the execution.

Another example aspect is directed to a non-transitory, computer-readable medium storing instructions that, when executed, cause one or more processors to perform operations. The operations comprising: receiving, by a computing system comprising one or more computing devices, one or more configuration parameters from one or more client devices; queueing, by a scheduler, a computer simulation configured based on the configuration parameters from the client device to be executed by one or more simulation engines; executing, by the one or more simulation engines, the computer simulation and storing the results in the computing system; and sending, from the computing device, the results output from the computer simulation to the client device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures.

FIG. 1 depicts a block diagram of an example computing system that hosts and executes computer simulations according to example embodiments of the present disclosure.

FIG. 2 depicts a block diagram of additional aspects of an example computing system for hosting and executing computer simulations according to example embodiments of the present disclosure.

FIG. 3 depicts a block diagram of additional aspects of an example computing system for hosting and executing computer simulations according to example embodiments of the present disclosure.

FIG. 4 depicts a block diagram of an example computer simulation that may be stored, manipulated, or executed via an example computing system according to example embodiments of the present disclosure.

FIG. 5 depicts a flow chart diagram of an example method to execute a computer simulation on a computing system according to example embodiments of the present disclosure.

FIG. 6 depicts a flow chart diagram of an example method to execute a computer simulation on a computing system according to example embodiments of the present disclosure.

FIG. 7 depicts a flow chart diagram of an example method to execute a computer simulation on a computing system according to example embodiments of the present disclosure.

FIG. 8 depicts a flow chart diagram of an example method to execute a computer simulation on a computing system according to example embodiments of the present disclosure.

Reference numerals that are repeated across plural figures are intended to identify the same features in various implementations.

### DETAILED DESCRIPTION

### Overview

The present disclosure relates to computer-implemented systems and methods for sharing, managing, and executing computer simulations via a simulation service. In one particular embodiment, the simulation service is stored and executed on a remote computing system. The computing system can be composed of one or multiple computing devices. The simulation service and remote computing system can be configured to interface with client devices/programs. Using the client devices or programs, a user may select a computer simulation stored within the simulation service to be executed. The simulation service will run the selected computer simulation on a simulation engine within the remote computing system and return results from the computer simulation to the client devices or programs. Example simulations that may be executed through the simulation service include, but are not limited to, traffic, chemical, biological, environmental, or similar simulations. In some instances, the results of the computer simulation may be streamed to the client devices or programs as they are obtained from the computer simulation allowing for real-time access to the results of the computer simulation.

In one particular instance, the user may create a configuration which comprises configuration parameters for a given computer simulation that may be applied to and executed through the given computer simulation. For example, a user may specify how long the computer simulation should run for (e.g., in terms of length of the simulation), which hardware or simulation engine within the remote computing system the computer simulation should be run on, or any other parameter associated with the simulation service, remote computing system, or the computer simulation itself that have been defined. After being created, the configuration may also be stored within the simulation service as a preset configuration for execution, viewing, or similar action by any user of the simulation service. In one instance, the user may also be able to specify a set of input data for a computer simulation to execute with. The set of input data may be stored on a client device and streamed to the simulation service as the computer simulation is being executed, or in some instances, the user may be able to select a set of input data from a plurality of data sets for execution with the computer simulation. In one particular embodiment, a set of input data or other dataset may be uploaded to the simulation service to be reused when desired. The set of input data may be uploaded through a standalone operation, or in some instances, the set of input data may be streamed to the simulation service as a computer simulation is being executed and will be uploaded through the execution.

In some embodiments, the computer simulations stored within the simulation service are uploaded to the simulation service and the remote computing device via the client devices or programs. Once a computer simulation is uploaded to the simulation service, it may be executed, modified, removed, or similar action by any other client devices or programs. For example, a user at one university may create and upload a computer simulation to the simulation service that peers working at different universities may utilize for their work. In another example, employees at a company with multiple offices may be able to upload and execute computer simulations as if they were all working on a computer system within the same office. It should be appreciated that these example scenarios are for descriptive purposes only. Any users of the simulation service may be able to access simulation services uploaded by other users or themselves within their group, firm, company, or similar. In one particular instance, a user may configure protections or settings for a given computer simulation that govern how or who may be able to see, access, or execute the given computer simulation.

Traditionally, implemented architecture for simulation execution is limited to a specific class or type of simulation at a software and even a hardware level. For example, the hardware that a given computer simulation is stored on is designed and built specifically for the given computer simulation. It could be incredibly difficult or impossible to effectively execute other computer simulations on the hardware. Furthermore, implemented architectures can be limited to a specific type of input, and as a result, are incapable of executing certain simulations or executing simulations with certain data. Certain currently implemented architectures also lack any sort of execution tracking or real time simulation monitoring. Output from implemented architectures also has significant drawbacks as compared to the present disclosure. With the current state of the art, output of computer simulations is often only available once the entire computer simulation is complete or it is limited by the medium of which it is transferred (i.e., a service emails the results which means only certain file sizes and formats can be returned).

As will be discussed in further detail below, the present disclosure seeks to and achieves improvement over the present state of the art by establishing a simulation service that produces reduced simulation time, reduced compute resource usage during the lifecycle of a computer simulation, more in-depth simulation analysis and monitoring, and allows for more accurate replication of simulation results.

With reference now to the Figures, example embodiments of the present disclosure will be discussed in further detail.

### Example Devices and Systems

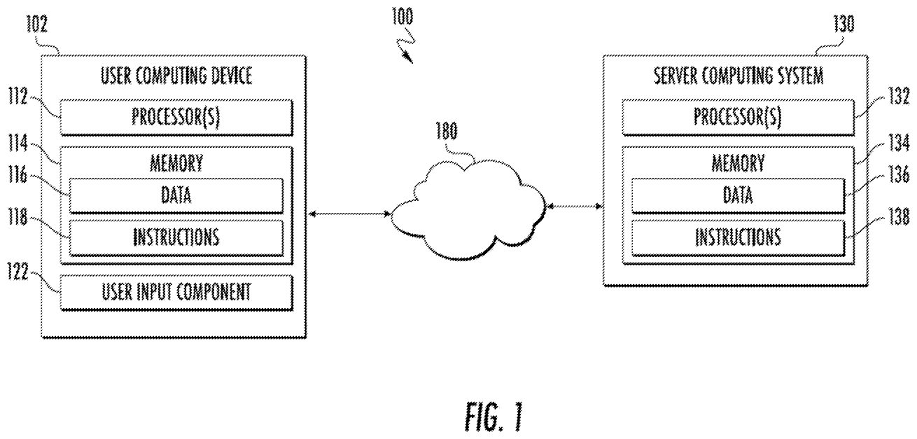

FIG. 1 depicts an example computing system 100 in which systems and methods in accordance with the present disclosure can be executed upon. The computing system comprises a user computing device 102 containing one or more processors 112, memory 114 which may contain data 116 and instructions 118 configured to carry out the methods disclosed herein, and a user input component 122. The user input component can be, for example, a touch display or physical buttons within the user computing device 102. The computing system 100 further comprises a network 180 and a server computing system 130.

The server computing system 130 comprises one or more processors 132, and memory 134 which may contain data 136 and instruction 138 configured to carry out the methods disclosed herein. For example, a user may select a computer simulation over the network 180 stored in memory 134 of the server computing system 130. The server computing system 130 may then execute instructions 138 pertaining to the selected computer simulation via the processor(s) 132. The simulation may then receive data from the user computer device 103 via the user input component 122 for use during execution.

The server computing system 130 may then send the results of the computer simulation back to the user computing device 102. In some instances, the results may be sent as soon as they are available (e.g., real-time), in others, the results are sent once the computer simulation has finished executing. It should be appreciated that any combination or order of systems and methods disclosed herein can be performed on the user computing device, server computing system, or similar. For example, all processes can be performed on the user computing device 102 or the server computing system 130.

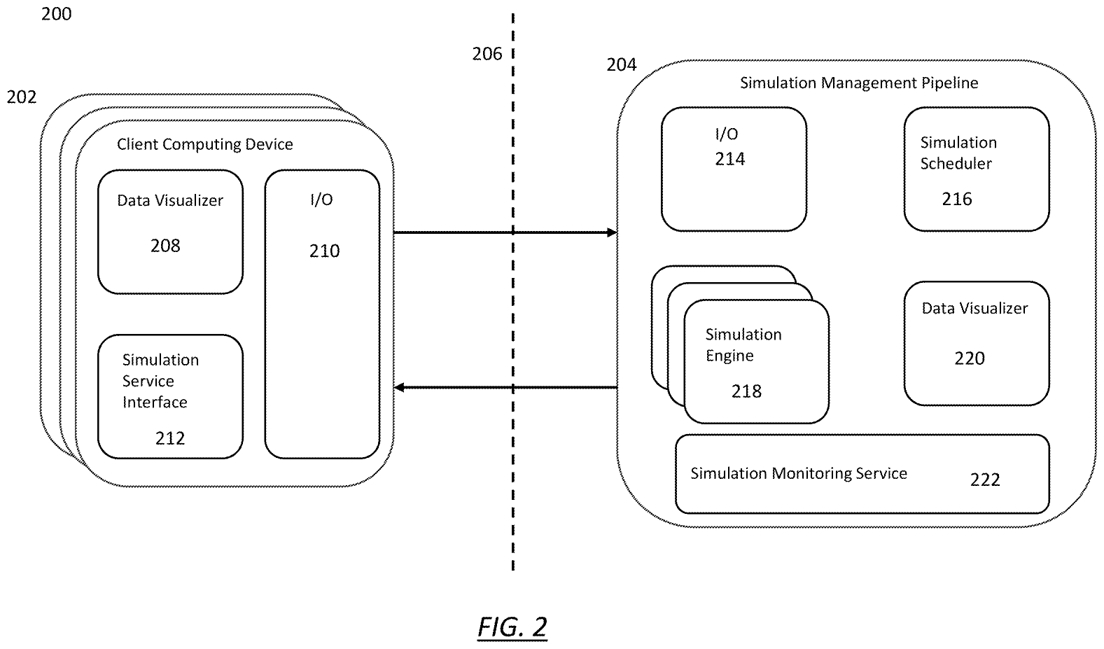

FIG. 2 depicts another example computing system 200 in accordance with aspects of the present disclosure. The computing system 200 comprises one or more client computing devices 202 and a simulation management pipeline 204 connected over a network 206. The one or more client computing devices 202 contain a data visualizer 208, an input and output interface 210, and a simulation service interface 212. In one particular embodiment, a user may communicate with the simulation management pipeline 204 through the input and output interface 210 using the simulation service interface 212. Through the simulation service interface 212, the user may select a computer simulation to be executed through the simulation management pipeline 204. In some instances, the user may send input data or configuration parameters for the computer simulation through the simulation management pipeline 204 to be used in an execution of the computer simulation.

In some instances, a user may select for the results of a computer simulation to be sent from the simulation management pipeline 204 directly to the data visualizer 208 stored within the one or more client computing devices 202. The data visualizer 208 may then generate a visualization of the results for the user to analyze and use. Example visualizations include, but are not limited to, scatter plots, bar charts, pie charts, or similar quantitative data analysis tools; videos, images, AR/VR environments, or similar generated works; and spreadsheets, archives, CSV files, logs, or similar large data format files. It should be appreciated that the example visualization embodiments disclosed herein are for descriptive purposes only. When in use, the visualizer 208 may generate a plurality of different embodiments the data received from the management pipeline 204. In one particular embodiment, the results of a computer simulation may be output to another service such as, for example, another simulation instance, or a data-storage service (e.g., cloud-storage platform). More generally, the user's configuration or command(s) can request the simulation service to interact with yet another service (e.g., to use the output of this other service, which might be, as examples, a simulation service, a storage service, or a map database service etc.).

The simulation management pipeline 204 consists of an input and output interface 214, a simulation scheduler 216, one or more simulation engines 218, a data visualizer 220, and a simulation monitoring service 222. In one particular embodiment, upon receiving a request to execute a computer simulation from the one or more client computing devices 202, the simulation management pipeline may queue the computer simulation to be executed on the one or more simulation engines 218 using the simulation scheduler 216. Example simulations that may be executed through the simulation management pipeline 204 include, but are not limited to, traffic, chemical, biological, environmental, or similar simulations.

In some instances, the simulation management pipeline 204 may receive configuration parameters and input data from the one or more client computing devices 202 for the computer simulation. In some instances, the configuration data may specify to output results of the simulation directly back to the one or more client computing devices 202 via the input and output interface 214. In other instances, the configuration data may specify to output the results to the data visualizer 220 to generate a visualization of the results and then send the visualization back to the one or more client computing devices 202.

In one particular embodiment, a user may upload a computer simulation to the simulation management pipeline 204 via the one or more client computing devices 202. Once the computer simulation has been uploaded, it may be executed on the one or more simulation engines 218 by any of the one or more client computing devices 202. For example, a user at one university may create and upload a computer simulation to the simulation management pipeline 204 via the one or more computing devices 202, that peers working at different universities may utilize for their work. In another example, employees at a company with multiple offices may be able to upload and execute computer simulations as if they were all working on a computer system within the same office. It should be appreciated that these example scenarios are for descriptive purposes only. Any users of the simulation service may be able to access simulation services uploaded by other users or themselves within their group, firm, company, or similar. Further, the user may assign permissions and configuration limitations to a computer simulation when uploading the computer simulation to the simulation management pipeline 204. For example, the user may assign who is allowed to execute the computer simulation and what parameters may be modified or changed during each execution of the computer simulation.

In some embodiments, the simulation monitoring service 222 may monitor a computer simulation while it is being executed through the one or more simulation engines 218. The simulation monitoring service may be configured to look for errors or failures within the computer simulation during execution. The simulation monitoring service 222 may then be able to halt, modify, or kill the computer simulation upon detecting the errors or failures within the computer simulation and notify the one or more client computing devices 202 accordingly.

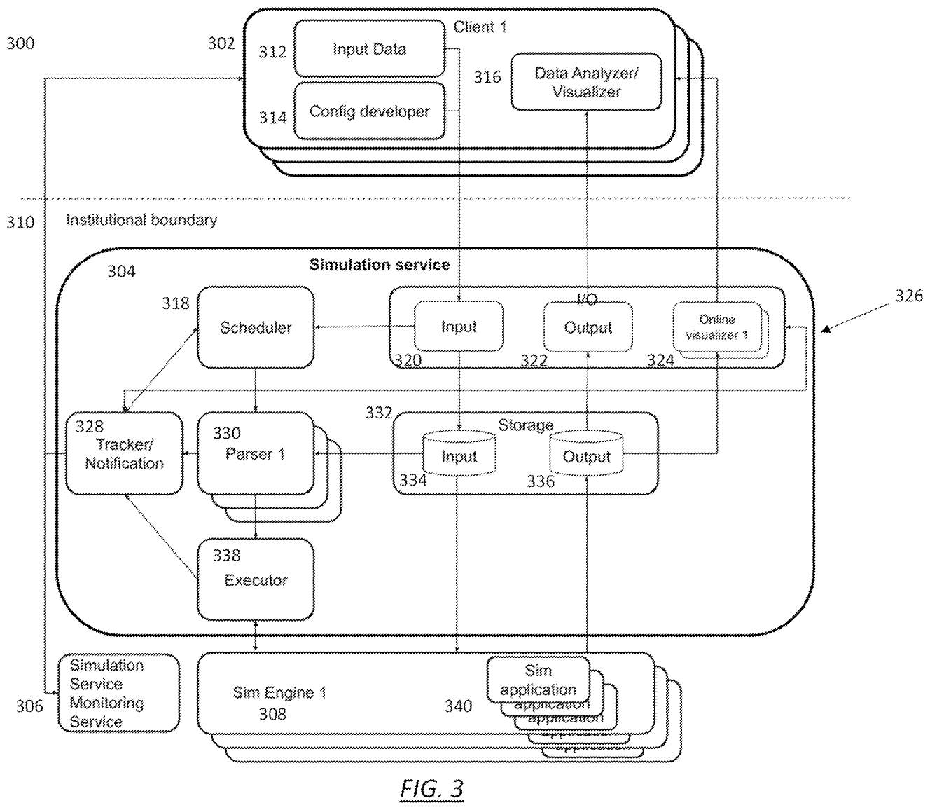

Referring now to FIG. 3, an example computing system 300 is shown in accordance with aspects of the present disclosure. The example computing system 300 consists of one or more client computing devices 302, a simulation service 304, a simulation service monitoring service 306, and one or more simulation engines 308. The one or more client computing devices 302 consist of input data 312, a configuration developer 314, and a data analyzer/visualizer 316. The simulation service 304 consists of a scheduler 318, an input and output interface 320, a simulation tracker 328, a simulation parser 330, storage 332, and an executor 338. The input and output interface 320 consists of input 322, output 324, and an online visualizer 326. The one or more simulation engines 308 consist of one or more simulation applications 340.

In one particular embodiment, a user may select a computer simulation stored within the simulation service 304 via the one or more client computing devices 302. In some instances, the user may also select input data 312 from the one or more client computing devices to be sent to the simulation service 304 to be used when executing the computer simulation. The user may also generate configuration parameters for the computer simulation using the configuration developer 314 to be used when executing the computer simulation. For example, the user may specify to use a dataset stored on the one or more client computing devices 302 with the computer simulation, and create a configuration that changes the number of executions of the computer simulation, and increases the granularity of the simulations calculations. The dataset and the configuration are then streamed to the simulation service 304 to be used when queueing, parsing, and executing the computer simulation. In one instance, the configuration parameters may also include how the output of the computer simulation should be handled.

The simulation service 304 may then queue the selected computer simulation for the one or more simulation engines 308 via the scheduler 318. Once the request has finished queuing, the configuration sent with the client request may be loaded onto the parser 330 to prepare for execution. The parser 330 will then prepare the configuration from the one or more client computing devices and pass the parsed info to the executor 338. The executor 338 will then assign and execute the computer simulation on the one or more simulation engines using the dataset from the one or more client computing devices, as well as the parsed info from the parser 330. As the computer simulation is executing, the results may be passed to the output 336 of the simulation service storage 332. The results may then be passed to the output 324 of the input and output interface 320 to be sent back to the one or more client computing devices 302. In some instances, the results of the computer simulation may be passed to the online visualizer 326 instead of directly to the one or more client computing devices 302. The online visualizer 326 may generate a visualization of the results of the computer simulation which it then sends to the one or more client computing devices.

In one particular embodiment, the simulation service monitoring service 306 may monitor the preparation and execution of a computer simulation once it has been selected by a user. The simulation service monitoring service 306 may then check for errors when queuing, parsing, executing, or any other step related to handling the computer simulation. If an error is detected, the simulation service monitoring service 306 may then halt, modify, or kill the computer simulation and notify the user. In some instances, the user may generate a configuration using the configuration developer 314 of the one or more client computing devices 302 that specifies certain errors to look for when the computer simulation is executing.

In some embodiments, a user may upload a computer simulation to the simulation service 304 from the one or more client computing devices 302. When uploading the computer simulation to the simulation service 304, the user may assign permissions to the computer simulation such as, for example, who may execute the computer simulation, who may see the computer simulation, and what may be configured, changed, or input to the computer simulation. Once the computer simulation is uploaded to the simulation service 304, any of the one or more client computing devices 302 may access or execute the computer simulation, given the necessary permissions.

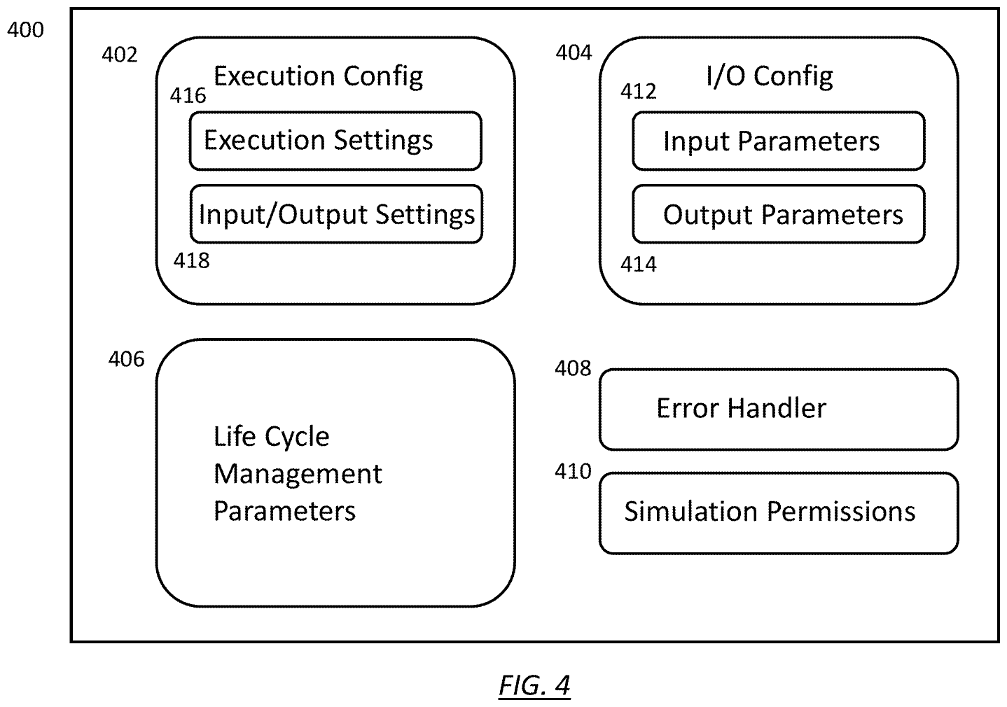

Referring now to FIG. 4, an example computer simulation 400 is provided according to aspects of the present disclosure. The computer simulation 400 comprises an execution configuration 402, and input and output configuration 404, life cycle management parameters 406, an error handler 408, and simulation permissions 410. The execution configuration 402 consists of execution settings 416 and input and output settings 418. In one particular embodiment, the execution settings 416 contain all possible values that may be edited or manipulated with each execution of a simulation. The execution settings may be defined when the computer simulation 400 is uploaded to a simulation service. The input and output settings 418 contain the individual execution input and output settings for each execution. The input and output settings 418 may be changed with each iteration of a computer simulation. In some instances, the input and output configuration contains input parameters 412 and output parameters 414 which contain the pre-determined allowable format for input and output of the computer simulation. For example, the input and output settings 418 of the execution configuration 402 may dictate the path for the input and output to be stored at, whereas the input parameters 412 and output parameters 414 dictate the file formats the computer simulation is capable of using.

In one particular embodiment, the life cycle management parameters 406 comprise rules for how the computer simulation should be managed during an execution of the computer simulation, as well as the life of the computer simulation itself. For example, the life cycle management parameters 406 may contain procedures for how to maintain the stability of the computer simulation if the software of a computer hosting it is altered or updated.

In some embodiments, the error handler 408 consists of a set of instructions or rules to be executed or followed during the event of an error during the execution of the computer simulation 400. For example, the error handler 408 may dictate that if an output result is a negative number, to halt the computer simulation and notify the user of the error. In another example, another computer simulation may have no mention of negative numbers in the error handler.

In one particular embodiment, the simulation permissions 410 comprise rules for who or what may access the computer simulation. For example, the simulation permissions 410 may be set such that only a certain type of user may modify the computer simulation, whereas another type of user may only be able to execute the simulation and may not modify it.

### Example Computer Simulations

Computer simulations include mathematical modelling, performed on a computer, which is designed to predict the behavior of, or the outcome of, a system such as a real-world or physical system. The reliability of some mathematical models can be determined by comparing their results to the real-world outcomes they aim to predict. Computer simulations can be a useful tool for the mathematical modeling of many systems, such as system relating to physics (e.g., computational physics), astrophysics, climatology, chemistry, biology, manufacturing, health care, and/or engineering. Simulation of a system can include running of the system's model. A computer system can be used to explore and gain new insights into new technology and to estimate the performance of systems too complex for analytical solutions.

Computer simulations can be executed by running computer programs that can be either small, running almost instantly on small devices, or large-scale programs that run for hours or days on network-based groups of computers. Because of the computational cost of simulation, computer experiments can be used to perform inference such as uncertainty quantification. A computer model can be or include algorithms and/or equations used to capture the behavior of the system being modeled. Computer simulation can include the actual running of the program that contains these equations or algorithms.

The external data requirements of simulations and models may vary. In some example, the input may be numerical (for example, simulation of a waveform of AC electricity on a wire), while others might require terabytes of information (such as weather and climate models). Input sources to simulations can include: Sensors and other physical devices connected to the model; Control surfaces used to direct the progress of the simulation in some way; Current or historical data entered by hand; Values extracted as a by-product from other processes; Values output for the purpose by other simulations, models, or processes.

The time at which data is available can also vary: “invariant” data is often built into the model code, either because the value is truly invariant (e.g., the value of it) or because the designers consider the value to be invariant for all cases of interest; data can be entered into the simulation when it starts up, for example by reading one or more files, or by reading data from a preprocessor; data can be provided during the simulation run, for example by a sensor network. Because of this variety, and because diverse simulation systems have many common elements, there are a large number of specialized simulation languages.

Systems that accept data from external sources can evaluate or represent the accuracy of the values. For example, this can be expressed as or using “error bars”, a minimum and maximum deviation from the value range within which the true value (is expected to) lie. An “error analysis” can be performed to confirm that values output by the simulation will still be usefully accurate.

Computer models can be classified according to several independent pairs of attributes, including, as examples: Stochastic or deterministic (and as a special case of deterministic, chaotic); Steady-state or dynamic; Continuous or discrete; Dynamic system simulation, e.g. electric systems, hydraulic systems or multi-body mechanical systems, or dynamics simulation of field problems, e.g. CFD of FEM simulations; Local or distributed.

Another way of categorizing models is to look at the underlying data structures. For time-stepped simulations, two main classes are: Simulations which store their data in regular grids and require only next-neighbor access are called stencil codes. Many CFD applications belong to this category. If the underlying graph is not a regular grid, the model may belong to the meshfree method class.

Equations can define the relationships between elements of the modeled system and attempt to find a state in which the system is in equilibrium. Such models are often used in simulating physical systems, as a simpler modeling case before dynamic simulation is attempted. Dynamic simulations can model changes in a system in response to (usually changing) input signals. Stochastic models can use random number generators to model chance or random events. A discrete event simulation (DES) can manage events in time. Some computer, logic-test and fault-tree simulations can be of this type. In some of this type of simulation, the simulator can maintain a queue of events sorted by the simulated time they should occur. The simulator can read the queue and trigger new events as each event is processed.

A continuous dynamic simulation can perform numerical solution of differential-algebraic equations or differential equations (either partial or ordinary). In some instances, the simulation program can solve (e.g., periodically) all the equations and uses the numbers to change the state and output of the simulation. Example applications include flight simulators, construction and management simulation games, chemical process modeling, and simulations of electrical circuits.

A special type of discrete simulation that does not rely on a model with an underlying equation, but can nonetheless be represented formally, is agent-based simulation. In some cases of agent-based simulation, the individual entities (such as molecules, cells, trees, or consumers) in the model are represented directly (e.g., rather than by their density or concentration) and can possess an internal state and set of behaviors or rules that determine how the agent's state is updated from one time-step to the next.

Distributed models can run on a network of interconnected computers. Simulations dispersed across multiple host computers like this are often referred to as “distributed simulations”. There are several standards for distributed simulation, including Aggregate Level Simulation Protocol (ALSP), Distributed Interactive Simulation (DIS), the High Level Architecture (simulation) (HLA) and the Test and Training Enabling Architecture (TENA).

In some implementations, output data from a computer simulation can be presented in a table or a matrix showing how data were affected by numerous changes in the simulation parameters. Additionally or alternatively, the output data can be represented in or using graphs or even moving-images or motion-pictures generated from the data, e.g., as displayed by computer-generated-imagery (CGI) animation. CGI computer simulations can be used to graphically display large amounts of data, in motion, as changes occur during a simulation run.

Example simulations can be used to understand or simulate various systems or processes, including, as examples:

A numerical simulation of differential equations that cannot be solved analytically (e.g., theories that involve continuous systems such as phenomena in physical cosmology, fluid dynamics (e.g., climate models, roadway noise models, roadway air dispersion models), continuum mechanics and chemical kinetics fall into this category).

A stochastic simulation (e.g., typically used for discrete systems where events occur probabilistically and which cannot be described directly with differential equations, including, as examples genetic drift, biochemical, or gene regulatory networks with small numbers of molecules.

A multiparticle simulation of the response of nanomaterials at multiple scales to an applied force for the purpose of modeling their thermoelastic and thermodynamic properties. Techniques used for such simulations can include Molecular dynamics, Molecular mechanics, Monte Carlo method, and Multiscale Green's function.

Statistical simulations based upon an agglomeration of a large number of input profiles, such as the forecasting of equilibrium temperature of receiving waters, allowing the gamut of meteorological data to be input for a specific locale. This technique can be used for thermal pollution forecasting.

Agent based simulation has been used effectively in ecology, where it is often called “individual based modeling” and is used in situations for which individual variability in the agents cannot be neglected, such as population dynamics of animals.

A time stepped dynamic model. In hydrology there are several such hydrology transport models such as the SWMM and DSSAM Models developed by the U.S. Environmental Protection Agency for river water quality forecasting.

Molecular modeling for drug discovery.

Modeling for viral infection (e.g., in mammalian cells).

Computational fluid dynamics simulations can be used to simulate the behavior of flowing air, water and other fluids. One-, two- and three-dimensional models can be used. A one-dimensional model might simulate the effects of water hammer in a pipe. A two-dimensional model might be used to simulate the drag forces on the cross-section of an airplane wing. A three-dimensional simulation might estimate the heating and cooling requirements of a large building.

Computer simulations can be used in a wide variety of practical contexts, such as:
Analysis of air pollutant dispersion using atmospheric dispersion modeling;
Design of complex systems such as aircraft and also logistics systems;
Design of noise barriers to effect roadway noise mitigation;
Modeling of application performance;
Flight simulators to train pilots;
Weather forecasting;
Forecasting of risk;
Simulation of electrical circuits;
Power system simulation;
Simulation of other computers, also known as emulation.
Forecasting of prices on financial markets;
Behavior of structures (such as buildings and industrial parts) under stress and other conditions;
Design of industrial processes, such as chemical processing plants;
Strategic management and organizational studies;
Reservoir simulation for the petroleum engineering to model the subsurface reservoir;
Process engineering simulation tools;
Robot simulators for the design of robots and robot control algorithms;
Urban simulation models that simulate dynamic patterns of urban development and responses to urban land use and transportation policies;
Traffic engineering to plan or redesign parts of the street network from single junctions over cities to a national highway network to transportation system planning, design and operations;
Modeling car crashes to test safety mechanisms in new vehicle models;
Crop-soil systems in agriculture, via dedicated software frameworks (e.g. BioMA, OMS3, APSIM);

Vehicle manufacturers can make use of computer simulation to test safety features in new designs. Engineers can step through the simulation milliseconds at a time to determine the exact stresses being put upon each section of the prototype.

Computer graphics can be used to display the results of a computer simulation. Animations can be used to experience a simulation in real-time. In some cases animations may also be useful in faster than real-time or even slower than real-time modes. For example, faster than real-time animations can be useful in visualizing the buildup of queues in the simulation of humans evacuating a building. Furthermore, simulation results can be aggregated into static images using various ways of scientific visualization.

In debugging, simulating a program execution under test can be used to detect errors and, at the same time, log useful debugging information such as instruction trace, memory alterations and instruction counts. This technique can also detect buffer overflow and similar “hard to detect” errors as well as produce performance information and tuning data.

### Example Methods

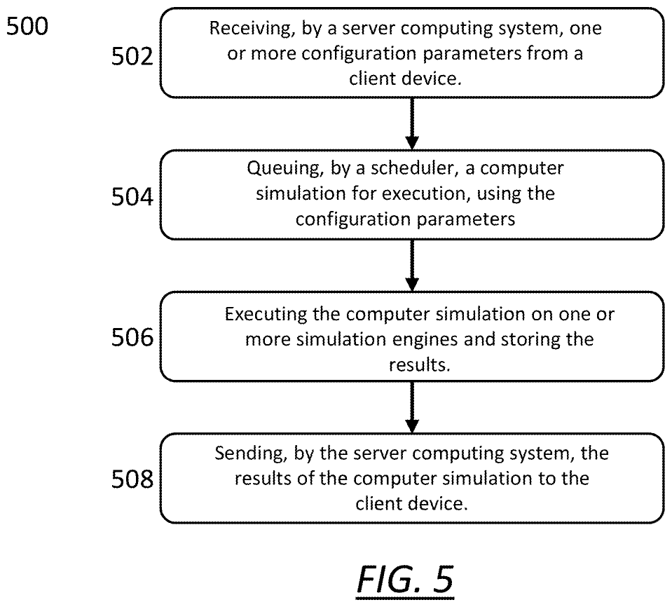

FIG. 5 depicts a flow chart diagram of an example method 500 to perform according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, the method includes receiving, by a server computing system, one or more configuration parameters from a client device. In one particular embodiment, the configuration parameters consist of different values to be applied to pre-defined modifiable variables within a computer simulation. For example, the configuration parameters may specify to execute the simulation with 400 cars and 2 hours of traffic for a traffic related computer simulation.

At 504, the method includes queuing, by a scheduler, a computer simulation, using the configuration parameters. Once the configuration parameters have been applied to the computer simulation, the computer simulation is ready for execution and scheduled to run.

At 506, the method includes executing the computer simulation on one or more simulation engines and storing the results.

At 508, the method includes sending, by the server computing system, the results of the computer simulation to the client device. In one particular embodiment, a user may specify whether the results should be sent as soon as they are available (e.g., real-time) or once the simulation has been completed.

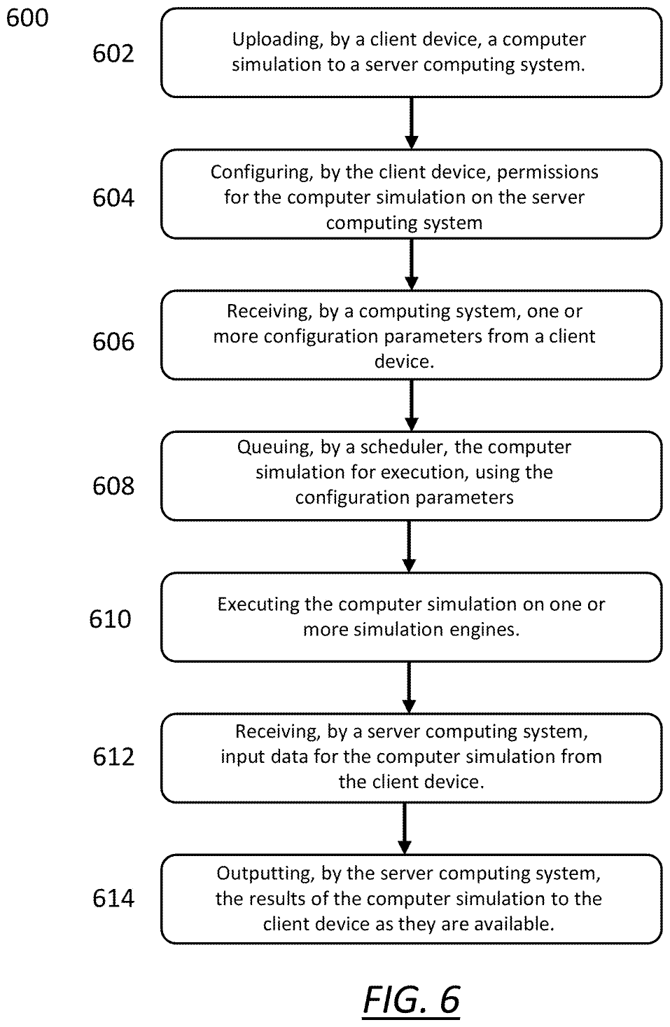

FIG. 6 depicts a flow chart diagram of an example method 600 to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, the method includes uploading, by a client device, a computer simulation to a server computing system.

At 604, the method includes configuring, by the client device, permissions for the computer simulation on the server computing system. In one particular embodiment, the permissions consist of who may view, modify, or execute the computer simulation on the server computing system. In some instances, the permissions may be predefined within the computer simulation and are automatically configured without the client device needing to configure them.

At 606, the method includes receiving, by a server computing system, one or more configuration parameters from a client device. In one particular embodiment, the configuration parameters consist of different values to be applied to pre-defined modifiable variables within a computer simulation. For example, the configuration parameters may specify to execute the simulation with 400 cars and 2 hours of traffic for a traffic related computer simulation.

At 608, the method includes queuing, by a scheduler, the computer simulation for execution, using the configuration parameters.

At 610, the method includes executing the computer simulation on one or more simulation engines. In one particular embodiment, the one or more simulation engines may be executed on a plurality of hardware, wherein each of the one or more simulation engines is restricted to a particular hardware architecture. For example, a simulation engine may be running on an architecture designed for high volume cross product matrix multiplication. Simulations requiring cross product matrix may be stored and executed by the simulation engine, however simulations requiring division may be stored and executed on a different simulation engine of the one or more simulation engines.

At 612, the method includes receiving, by a server computing system, input data for the computer simulation from the client device. In one particular embodiment, the input data for the computer simulation is a dataset stored locally on the server computing system or is stored on a separate remote computing system. The client device may specify where to retrieve the input data from instead of directly supplying the input data in those instances.

At 614, the method includes outputting, by the server computing system, the results of the computer simulation to the client device as they are available. In one particular embodiment, a user may specify whether the results should be sent as soon as they are available (e.g., real-time) or once the simulation has been completed.

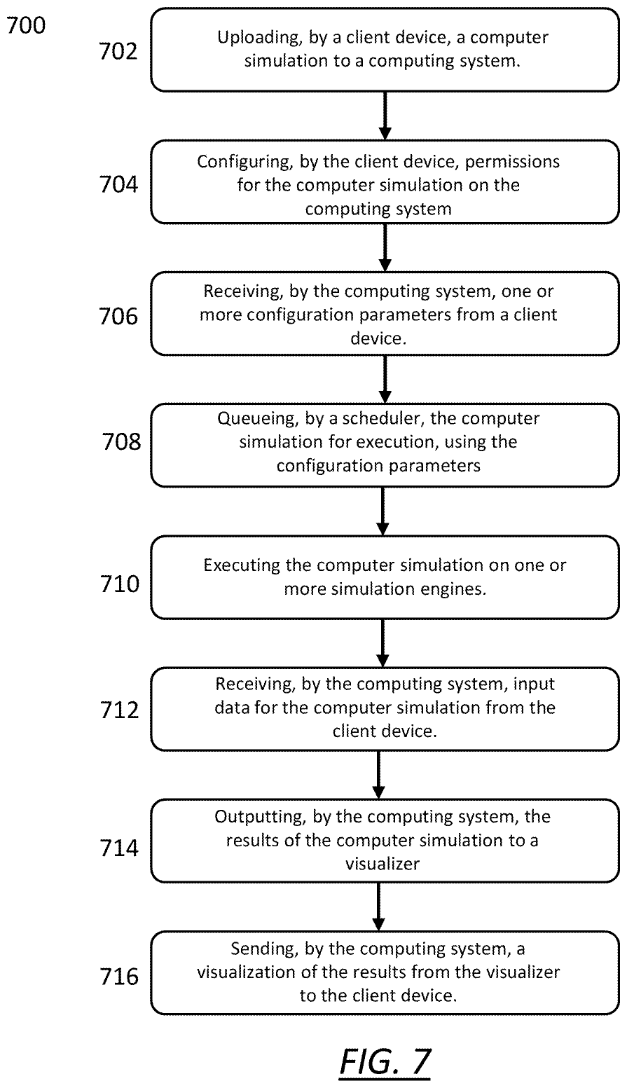

FIG. 7 depicts a flow chart diagram of an example method 700 to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, the method includes uploading, by a client device, a computer simulation to the server computing system.

At 704, the method includes configuring, by the client device, permissions for the computer simulation on the server computing system. In one particular embodiment, the permissions consist of who may view, modify, or execute the computer simulation on the server computing system. In some instances, the permissions may be predefined within the computer simulation and are automatically configured without the client device needing to configure them.

At 706, the method includes receiving, by the server computing system, one or more configuration parameters from a client device. In one particular embodiment, the configuration parameters consist of different values to be applied to pre-defined modifiable variables within a computer simulation. For example, the configuration parameters may specify to execute the simulation with 400 cars and 2 hours of traffic for a traffic related computer simulation.

At 708, the method includes queueing, by a scheduler, the computer simulation for execution, using the configuration parameters.

At 710, the method includes executing the computer simulation on one or more simulation engines. In one particular embodiment, the one or more simulation engines consists of a plurality of hardware, wherein each of the one or more simulation engines is associated with a dedicated hardware architecture, and each architecture is designed for a specific type of simulation. For example, a simulation engine may be running on an architecture designed for high volume cross product matrix multiplication. Simulations requiring cross product matrix may be assigned to the simulation engine, however simulations requiring division may be left queueing for a different simulation engine of the one or more simulation engines.

At 712, the method includes receiving, by the server computing system, input data for the computer simulation from the client device. In one particular embodiment, the input data for the computer simulation is a dataset stored locally on the server computing system or is stored on a separate remote computing system. The client device may specify where to retrieve the input data from instead of directly supplying the input data in those instances.

At 714, the method includes outputting, by the server computing system, the results of the computer simulation to a visualizer.

At 716, the method includes sending, by the server computing system, a visualization of the results from the visualizer to the client device. In one particular embodiment, when the visualization from the results should be sent to the client device may be as soon as individual points are available (e.g., real-time) or once all the results have been provided to the visualizer and the computer simulation is finished.

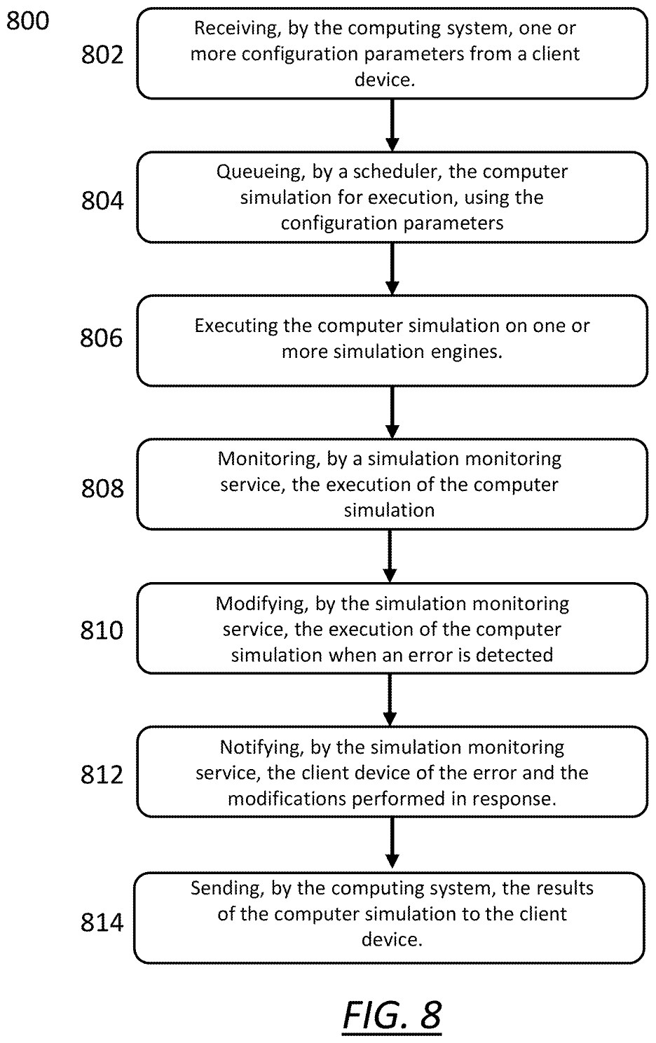

FIG. 8 depicts a flow chart diagram of an example method 800 to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, the method includes receiving, by a server computing system, one or more configuration parameters from a client device. In one particular embodiment, the configuration parameters consist of different values to be applied to pre-defined modifiable variables within a computer simulation. For example, the configuration parameters may specify to execute the simulation with 400 cars and 2 hours of traffic for a traffic related computer simulation.

At 804, the method includes queuing, by a schedule, a computer simulation, using the configuration parameters. Once the configuration parameters have been applied to the computer simulation, the computer simulation is ready for execution and scheduled to run.

At 806, the method includes executing the computer simulation on one or more simulation engines.

At 808, the method includes monitoring, by a simulation monitoring service, the execution of the computer simulation.

At 810, the method includes modifying, by the simulation monitoring service, the execution of the computer simulation when an error is detected. In one particular embodiment, the computer simulation may contain predefined rules or instructions for handling errors during the execution of the computer simulation. For example, the computer simulation may indicate that a negative number is an error, therefore the simulation monitoring service will modify the execution of the simulation upon identifying a negative number.

At 812, the method includes notifying, by the simulation monitoring service, the client device of the error and the modifications performed in response.

At 814, the method includes sending, by the server computing system, the results of the computer simulation to the client device. In one particular embodiment, when the visualization from the results should be sent to the client device may be as soon as individual points are available (e.g., real-time) or once all the results have been provided to the visualizer and the computer simulation is finished.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

What is claimed is:

1. A computing system for executing software simulations, comprising:
one or more processors;
a computer readable storage medium comprising one or more computer simulations;
a simulation management pipeline comprising a simulation engine, a scheduler, and an input interface, wherein:
the simulation engine is configured to run the one or more computer simulations stored within the computer-readable storage medium,
the scheduler is configured to queue the one or more computer simulations for the simulation engine, and
the input interface is configured to receive configuration parameters for the one or more computer simulations stored within the computing system.

2. The computing system of claim 1, wherein the simulation engine is further configured to run the one or more computer simulations based on the configuration parameters sent to the input interface via the client computing device.

3. The computing system of claim 1, wherein the simulation engine comprises a plurality of computing devices, and each of the plurality of computing devices is capable of running one or more computer simulations.

4. The computing system of claim 1, wherein the computing system further comprises one or more client computing device configured to send configuration parameters to the input interface of the simulation management pipeline.

5. The computing system of claim 4, wherein the one or more computer simulations are uploaded to the computer-readable storage medium via the one or more client computing devices.

6. The computing system of claim 5, wherein the input interface is further configured to output the results of the simulation engine to the one or more client computing devices or one or more other computing devices.

7. The computing system of claim 6, wherein the results of the simulation engine are output to the client computing device as soon as they are generated.

8. The computing system of claim 6, wherein the results of the simulation engine are input to a visualizer to generate a results visualization that is output to the client computing device.

9. The computing system of claim 1, wherein the simulation management pipeline further comprises a simulation monitoring service configured to monitor the simulation management pipeline and the simulation engine during execution of the one or more computer simulations.

10. The computing system of claim 9, wherein the simulation monitoring service is further configured to modify the execution of the one or more computer simulations when an error occurs during the execution.

11. A computer-implemented method for executing computer simulations, comprising:
receiving, by a computing system comprising one or more computing devices, one or more configuration parameters from a client device;
queueing, by a scheduler, a computer simulation configured based on the configuration parameters from the client device to be executed by one or more simulation engines;
executing, by the one or more simulation engines, the computer simulation and storing the results in the computing system; and
sending, from the one or more computing devices, the results output from the computer simulation to the one or more client devices.

12. The computer-implemented method of claim 11, further comprising:
receiving, by the computing system, input data from the one or more client devices.

13. The computer-implemented method of claim 11, further comprising:
uploading, by the one or more client devices, one or more computer simulations to the computing system to be stored and executed.

14. The computer-implemented method of claim 13, further comprising:
configuring, by the one or more client devices, permissions of the one or more computer simulations uploaded to the computing system that control how the one or more computer simulations may be executed and who the one or more computer simulations may be executed by.

15. The computer-implemented method of claim 11, wherein the results output from the computer simulation to the client device are transmitted as soon as they are available.

16. The computer-implemented method of claim 11, wherein the results output from the computer simulation are sent to a visualizer to generate a visualization of the results and the visualization is output to the one or more client devices.

17. The computer-implemented method of claim 11, wherein the computing system further comprises a simulation monitoring service.

18. The computer-implemented method of claim 17, further comprising:
monitoring, by the simulation monitoring service, the one or more simulation engines to detect errors during an execution of the computer simulation.

19. The computer-implemented method of claim 18, further comprising:
modifying, by the simulation monitoring service, the execution of the computer simulation after detecting an error during the execution.

20. A non-transitory, computer-readable medium storing instructions that, when executed, cause one or more processors to perform operations, the operations comprising:
receiving, by a computing system comprising one or more computing devices, one or more configuration parameters from one or more client devices;
queueing, by a scheduler, a computer simulation configured based on the configuration parameters from the client device to be executed by one or more simulation engines;
executing, by the one or more simulation engines, the computer simulation and storing the results in the computing system; and
sending, from the computing device, the results output from the computer simulation to the client device.
